(19) United States
(12) Patent Application Publication
(10) Pub. No.: US 2014/0281099 A1
(43) Pub. Date: Sep. 18, 2014

(54) METHOD, SYSTEM, AND COMPUTER PROGRAM PRODUCT FOR CONTROLLING FLOW OF PCIe TRANSPORT LAYER PACKETS

(71) Applicant: BROADCOM CORPORATION, Irvine, CA (US)

(72) Inventors: Refeal AVEZ, Petach Tikva (IL); Danny Kopelev, Netanya (IL)

(73) Assignee: Broadcom Corporation, Irvine, CA (US)

(21) Appl. No.: 13/804,140

(22) Filed: Mar. 14, 2013

(51) Int. Cl. G06F 13/30

(52) U.S. Cl. CPC G06F 13/30
USPC 710/308; 710/309; 710/310

(57) ABSTRACT

This application relates to systems and methods for controlling the flow of transport layer packets (TLP) in a peripheral component interconnect express (PCIe)-based environment. In an exemplary embodiment, an arbiter in a PCIe device determines the amount of data, if any, that should be expected in response to transmission of a particular TLP. If a receive buffer of the PCIe device has enough available space for storing the expected data, the arbiter permits transmission of the particular TLP. If the receive buffer does not have enough available space for storing the expected data, the arbiter suppresses transmission of the particular TLP until the receive buffer has enough available space. The exemplary embodiment may improve data flow through the PCIe environment by reducing fragmented transfers of data.

### FIELD

Embodiments of the disclosure relate generally to peripheral component interconnect express (PCIe) transport layer packets. More specifically, embodiments of the disclosure relate to controlling the flow of transport layer packets in a PCIe-based environment.

### BACKGROUND

The Peripheral Component Interconnect (PCI) local bus standard is directed to interconnecting hardware devices in a computer system. The PCI Express (PCIe) is one of various evolutionary improvements to PCI, and significantly differs from PCI. A particular difference in PCIe is the use of one-to-one serial connections (or lanes) between each PCIe device (i.e., a PCIe End Point) and the computer's CPU (i.e., a PCIe root complex) instead of a local bus shared by all devices and the CPU. This and other differences allow PCIe devices to exchange data with the CPU at significantly higher rates than was possible in earlier PCI standards.

In PCIe, a device coupled to a particular link of a lane, for example a PCIe End Point, a PCIe switch, or a PCIe root complex, includes a receiving buffer of limited storage capacity for receiving data from a corresponding link-mate. A receiving device controls the flow of data into its receiving buffer by sharing with the corresponding link-mate how mach storage capacity, represented as a number of flow control credits, is available in its receiving buffer. The transmitting link-mate sends data to the receiving device only if there are enough flow control credits in the device to receive such data. Therefore, in PCIe, data flow control is performed on a per-link basis by both devices sharing the link.

### BRIEF DESCRIPTION OF THE DRAWINGS/FIGURES

FIG. 1 is a block diagram of a PCIe environment according to an exemplary embodiment.

FIG. 2 is a block diagram of a packet arbiter according to an exemplary embodiment.

FIG. 3 is a flowchart illustrating a process for controlling the flow of packets according to an exemplary embodiment.

FIG. 4 is a flowchart illustrating a process for controlling the flow of packets according to another exemplary embodiment.

FIG. 5 is an exemplary computer system useful for implementing various exemplary embodiments.

### DETAILED DESCRIPTION OF THE INVENTION

The following Detailed Description refers to accompanying drawings to illustrate various exemplary embodiments. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

It is to be appreciated that the Detailed Description section, and not the Abstract section, is intended to be used to interpret the claims. The Abstract section may set forth one or more but not all exemplary embodiments of the present disclosure as contemplated by the inventor, and thus, is not intended to limit the present invention and the appended claims in any way.

FIG. 1 is a diagram 100 for describing a PCIe interface according to an exemplary embodiment of the present disclosure. Diagram 100 includes PCIe device 105, PCIe link 115, PCIe root complex 120, CPU 125, and CPU memory subsystem 130. A person of ordinary skill in the art would understand that a PCIe environment may include more or less elements than those illustrated in FIG. 1. In the embodiment, PCIe device 105 is a two-port 10 gigabit per second passive optical network (XG-PON) network interface integrated circuit that exchanges data with CPU 125 through PCIe link 115. However, PCIe device 105 may be any PCIe device that can exchange data through a PCIe link with a corresponding PCIe device.

PCIe device 105 includes a plurality of direct memory access (DMA) engines (106-0-106-n) which may independently exchange data with CPU 125 through PCIe link 115. PCIe device 105 further includes a Transport Layer Packet (TLP) arbiter 107 to determine/schedule which DMA engines 106-0-106-n may exchange data with CPU 125 through PCIe link 115.

PCIe device 105 further includes RX engine and ingress buffer 108 to store data received in response to a DMA engine's TLP packet requesting such data and to provide such data to the corresponding DMA upon request. In operation, RX engine and ingress buffer 108 stores data received through PCIe link 115 until the corresponding DMA engine retrieves the data. Thus, its available capacity, or number of flow control credits, varies as data is received through PCIe link 115 and retrieved by its corresponding DMA engine. In the present embodiment, RX engine and ingress buffer 108 is coupled to TLP arbiter 107 and provides TLP arbiter 107 periodically, automatically, or upon request, the number of flow control credits available at a given time.

PCIe End Point 110 is an interface between PCIe device 105 and PCIe link 115. Although in the embodiment PCIe End Point 110 is shown embedded in PCIe device 105, the present disclosure is not so limited, and PCIe device 105 may be separate from PCIe device 105. PCIe link 115 is a full duplex communication link between PCIe End Point 110 and PCIe root complex 120. PCIe root complex 120 connects CPU 125, and any associated memory subsystem, such as CPU memory subsystem 130, to PCIe devices through one or more PCIe links, such as PCIe link 115. In the present embodiment, PCIe End Point 110, PCIe link 115, and PCIe root complex 120 perform according to the PCIe standard, and their particularities would not be described in further detail to not obscure elements of the present disclosure.

As will be explained in further detail below, in various exemplary embodiments of the disclosure, TLP arbiter 107 may receive a TLP from a DMA engine, such as DMA Engine 106-0, for transmission towards CPU memory subsystem 130 through PCIe link 115. TLP arbiter 107 may parse the TLP and determine the amount of data, if any, that should be expected from CPU memory subsystem 130, in response to the TLP. TLP arbiter 107 may also determine how much storage capacity, as a number of flow control credits, remain in RX engine and ingress buffer 108. If there are enough flow control credits to receive the amount of data expected in response to the TLP, TLP arbiter 107 transmits the TLP towards CPU memory subsystem 130 through PCIe End Point 110, PCIe link 115, and PCIe root complex 120. If, on the other hand, there are not enough flow control credits to receive the amount of data expected in response to the TLP, TLP arbiter 107 holds the TLP until there are enough flow control credits to receive all the data being requested in the TLP. This may improve flow through the PCIe environment by, for example, allowing full uninterrupted data transfers to occur, as opposed to fragmented transfers that may occur when a PCIe device does not have enough flow control credits to receive all incoming data in a single and uninterrupted data transfer.

FIG. 2 is a block diagram of a TLP arbiter 200 according to an exemplary embodiment of the present disclosure. TLP arbiter 200 includes interface 201 for communicating with one or more devices (not shown) coupled to TLP arbiter 200, such as DMA engines 106-0-106-n illustrated imp FIG. 1. TLP arbiter 200 further includes round robin (RR) modules 205-208, coupled to interface 201, for receiving TLPs of a corresponding type from devices of a corresponding priority coupled to TLP arbiter 200, such as DMA engines 106-0-106-n illustrated in FIG. 1. Each round robin module schedules its received TLPs in a round robin manner (i.e., sequentially and non-prioritized). Specifically, in the present embodiment, RR module 205 schedules high priority non-posted (NP) messages in a round robin manner, RR module 206 is schedules low priority NP messages in a round robin manner, RR module 207 schedules high priority posted (P) messages in a round robin manner, and RR module 208 schedules low priority P messages in a round robin manner.

TLP arbiter 200 further includes credit test modules 210 and 211, coupled to NP RR modules 205 and 206, respectively, and further coupled to a receive buffer (not shown), such as RX engine and ingress buffer 108 illustrated in FIG. 1, to determine the amount of flow control credits available for receiving data from the PCIe environment. As will be explained in further detail below, credit test modules 210 and 211 suppress sending of a corresponding NP TLP when there are not enough flow control credits available for storing data requested by the corresponding NP TLP. In the present embodiment, a credit test module performs suppression by indicating to the corresponding NP RR module to hold transferring/sending of the NP TLP. A person of ordinary skill in the art would understand that a credit test module may perform suppression by holding the TLP in a separate buffer or in a buffer within. Note that credit test modules are not necessary for P TLPs, and thus no credit test module is coupled to P RR modules, because data is not generally expected from CPU memory subsystem 130 in response to P TLPs. Accordingly, P TLPs need not be suppressed regardless of the number of flow control credits available in RX engine and ingress buffer 108.

TLP arbiter 200 further includes priority module 215, coupled to RR modules 205-208, for further scheduling of TLPs based on a priority associated with each RR module.

In the present embodiment, although described in terms of multiple modules, a person of ordinary skill in the art would understand that TLP arbiter 200 may be embodied in one or more processors and/or circuits and may further include a readable medium having control logic (software) stored therein. Such control logic, when executed by the one or more processors, causes them to operate as described herein.

In the present embodiment, a plurality of devices, such as DMA engines 106-0-106-n, and TLP arbiter 200, are part of a PCIe device coupled to a root complex, such as PCIe root complex 120 illustrated in FIG. 1, within a PCIe environment, such as PCIe environment 100 illustrated in FIG. 1. The plurality of devices provide TLP arbiter 200 P and NP TLPs that may be either of high priority or low priority. The TLPs are routed to corresponding RR modules of RR modules 205-208 depending on their type (P or NP) and priority (high or low priority). RR modules 205-208 schedule their TLPs in a round-robin manner and provide the next-scheduled TLP to priority module 215, which in turn schedules transmission of the TLP through the PCIe environment.

In the present embodiment, when an NP RR module, such as NP RR modules 205 and 206, schedules an NP TLP for transmission, it uses its corresponding credit test module (210 or 211) to parse the TLP and extract from its length field the amount of data expected in response to the NP TLP. The corresponding credit test module compares the amount of data expected in response to the amount of available flow control credits at the receive buffer (not shown) and determines whether there are enough flow control credits to receive the amount of data expected. If there are not enough flow control credits, the corresponding credit test module suppresses the corresponding NP RR module from sending the TLP until enough flow control credits become available. As noted above with respect to RX engine and ingress buffer 108 illustrated in FIG. 1, flow control credits become available when data received at RX engine and ingress buffer 108 for a particular DMA engine is retrieved by the particular DMA engine.

In the exemplary embodiment, TLP arbiter 200 relies on DMA Engines 106-0-106-n to provide a PCIe-compliant NP TLP. A person of ordinary skill in the art would understand that TLP arbiter 200 may test and correct received NP TLPs consistent with the PCIe standard. For example, a credit test module (210 or 211) may test whether the length/address combination in the NP TLP crosses a CPU memory subsystem 130 memory block boundary and, if necessary, reconfigure the NP TLP consistent with the PCIe standard. Furthermore, the credit test module (210 or 211) may test whether the length in the NP TLP meets a corresponding payload size restriction and, if necessary, reconfigure the NP TLP consistent with the PCIe standard.

Furthermore, in the present embodiment, priority module 205 receives requests for sending TLPs from the RR modules and may select which TLP to schedule for sending through the PCIe environment based on a criteria. A person of ordinary skill in the art would understand that such criteria may include a pre-determined priority for each RR module, a pre-determined priority or each of the devices coupled to interface 201 (not shown), and/or a particular characteristic of the TLP.

Accordingly, in the present embodiment, a NP TLP for transmission from a PCIe device through a PCIe environment is suppressed when an associated receive buffer for receiving data requested in the NP TLP does not have enough space flow control credits) for storing the requested data.

FIG. 3 is a now diagram 300 of a method for controlling the flow of a PCIe NP TLP according to an exemplary embodiment of the present disclosure. The flowchart is described with continued reference to the embodiments of FIG. 1 and FIG. 2. However, flowchart 300 is not limited to those embodiments.

At block 305, TLP arbiter 200 receives a NP TLP from DMA engine 106-0. At block 310, credit test module 210 parses the NP TLP to get the amount of data requested in the NP TLP. At block 315, credit test module 210 reads, from Rx engine and ingress buffer 108, the amount of flow control credits available to store the data requested. At block 320 credit test module 210 determines if there are enough flow control credits to receive the data requested. If there are enough flow control credits available, at block 325, TLP arbiter 200 sends the NP TLP through the PCIe environment towards PCIe root complex 120, if there are not enough flow control credits available, credit test module 210 suppresses sending the NP TLP until enough flow control credits become available for sending the NP TLP through the PCIe environment towards PCIe root complex 120.

Accordingly, in the present embodiment, a NP TLP is analyzed and provided for transmission from a PCIe device through a PCIe environment when an associated receive buffer for receiving data requested in the NP TLP does has enough space (i.e., flow control credits) for storing the requested data, and queued when an associated receive buffer for receiving data requested in the NP TLP does has enough space (i.e., flow control credits) for storing the requested data.

FIG. 4 is a flow diagram 400 of another method for controlling the flow of a PCIe NP TLP according to an exemplary embodiment of the present disclosure. The flowchart is described with continued reference to the embodiments of FIG. 1 and FIG. 2. However, flowchart 400 is not limited to those embodiments.

At block 405, TLP arbiter 200 receives a TLP from DMA engine 106-0. At block 410. TLP arbiter queues the TLP in a corresponding RR module depending on its type (P or NP) and priority (high or low) designation. At block 415, priority module 215 selects an RR module to send a TLP through the associated PCIe environment. At block 420, if the selected RR module's next TLP is a NP TLP (“yes” path of block 420), TLP arbiter 200 parses the TLP to obtain the amount of data requested by the TLP (block 425) and reads from Rx engine and ingress buffer 108 the amount of flow control credits available to store the data requested (block 430). If the selected module's next TLP is a P TLP (“no” path of block 420), at block 440 TLP arbiter 200 sends the TLP through the PCIe environment towards PCIe root complex 120.

At block 435 TLP arbiter 200 determines if there are enough flow control credits to receive the amount of data requested in the TLP. If there are enough flow control credits available, at block 440, TLP arbiter 200 sends the TLP through the PCIe environment towards PCIe root complex 120. If there are not enough flow control credits available, TLP arbiter 200 suppresses sending the TLP until enough flow control credits become available (returns to block 430).

Accordingly, in the present embodiment, a TLP is analyzed and provided for transmission through a PCIe environment when the TLP is a P TLP. If the UP is a NP TLP, the embodiment checks if there is enough space to receive data requested in the TLP. If there is enough space, the embodiment provides the TLP for transmission through a PCIe environment. If there is not enough space, the embodiment queues the TLP until there is enough space to receive data requested in the TLP.

Various embodiments can be implemented, for example, within one or more well-known computer systems, such as computer system 500 shown in FIG. 5. Computer system 500 includes one or more CPUs, such as a CPU 504 and CPU 125 illustrated in FIG. 1. CPU 504 is connected to a communication infrastructure 506, which may be based on a. PCIe local bus standard. Accordingly, communication infrastructure 506 may include PCIe links such as PCIe link 115 illustrated in FIG. 1.

Computer system 500 also includes user input/output device(s) 503, such as monitors, keyboards, pointing devices, etc., which communicate with communication infrastructure 506 through user input/output interface(s) 502.

Computer system 500 also includes a main or primary memory 508, such as random access memory (RAM). Main memory 508 may include one or more levels of cache. Main memory 508 may have stored therein control logic (i.e., computer software) and/or data, and may be accessed by other devices within computer system 500 via PCIe lanes. Thus, main memory 508 may be embodied by memory subsystem 130 illustrated in FIG. 1.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive. Secondary memory 510 may be accessed by other devices within computer system 500 via PCIe lanes. Thus, secondary memory 510 may be embodied by memory subsystem 130 illustrated in FIG. 1.

Computer system 500 may further include a communication or network interface 524. Communication interface 524 enables computer system 500 to communicate and interact with any combination of remote devices, remote networks, remote entities, etc. (individually and collectively referenced by reference number 528), through Communication infrastructure 506. For example, communication interface 524 may allow computer system 500 to communicate with remote devices 528 over communications path 526, which may be wired and/or wireless, and which may include any combination of LANs, WANs, the Internet, etc. Communication interface 524 may include a PCIe device and may be embodied by PCIe device 105 illustrated in FIG. 1. Control logic and/or data may be transmitted to and from computer system 500 via communication path 526.

In an exemplary embodiment, a non-transitory apparatus or article of manufacture comprising a non-transitory computer useable or readable medium having control logic (software) stored thereon is also referred to herein as a computer program product or program storage device. Such control logic, when executed by one or more processors within the particular non-transitory apparatus or article of manufacture, causes the exemplary embodiment to operate as described herein.

Based on the teachings contained in this disclosure, it will be apparent to persons skilled in the relevant art(s) how to make and use the invention using data processing devices, computer systems and/or computer architectures other than that shown in FIG. 5. In particular, embodiments may operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments so fully reveal the general nature of the disclosure that others can, by applying knowledge within the skill of the art, readily modify and/or adapt such specific embodiments for various applications, without undue experimentation and without departing from the general concept of the present disclosure. Therefore, such modifications and/or adaptations are intended to be within the meaning and range of equivalents of the disclosed embodiments; based on the teaching and guidance presented herein. It is to be understood that the phraseology or terminology herein is for the purpose of description and not of limitation, and as such, it is to be interpreted by the skilled artisan, in light of the teachings and guidance presented therein.

What is claimed is:

1. A method for controlling communications in a PCIe environment by a PCIe device, the method comprising:
receiving a request for data message addressed to a remote device, wherein the request for data message includes a requested data value;
queuing the request for data message when storage space available at the PCIe device for receiving data from the remote device is less than the requested data value; and
sending the request for data message to the remote device when storage space available at the PCIe device for receiving data from the remote device is at least the requested data value.

2. The method of claim 1, further comprising:
parsing the request for data message to retrieve the requested data value.

3. The method of claim 1, further comprising;
monitoring the storage space available at the PCIe device for receiving data from the remote device when the request for data message is queued.

4. The method of claim wherein:
the request for data message comprises a non-posted transport layer packet read request from a DMA engine of a plurality of DMA engines.

5. The method of claim 4, further comprising:
receiving a plurality of messages from the plurality of DMA engines, wherein at least one of the messages of the plurality of messages includes a requested data value;
arbitrating the plurality of messages and the request for data message based on whether they include a requested data value; and
selecting the request for data message based on the arbitrating.

6. The method of claim 4, further comprising:
receiving a plurality of messages from the plurality of DMA engines, wherein at least one of the messages of the plurality of messages includes a requested data value;
arbitrating the plurality of messages and the request for data message based on whether they include a requested data value and on a predetermined priority; and
selecting the request for data message based on the arbitrating.

7. The method of claim 4, further comprising:
receiving a plurality of messages from the plurality of DMA engines, wherein at least one of the messages of the plurality of messages includes a requested data value;
arbitrating the plurality of messages and the request for data message based on whether they include a requested data value, on a DMA engine round robin methodology, and on a DMA engine priority methodology; and
selecting the request for data message based on the arbitrating.

8. A PCIe device comprising:
a memory buffer; and
at least one processor coupled to the memory buffer and configured to:
receive a request for data message that requests data from a remote device, the request for data message including a requested data value;
queue the request for data message when storage space available in the memory buffer for receiving data in response to the request for data message is less than the requested data value; and
sending the request for data message to the remote device when the storage space available in the memory buffer for receiving data in response to the request for data message is at least the requested data value.

9. The PCIe device of claim 8, wherein:
the at least one processor is further configured to:
parse the request for data message to retrieve the requested data value.

10. The PCIe device of claim 8, wherein:
the at least one processor is further configured to:
monitor the storage space available in the memory buffer for receiving data from the remote device when the request for data is queued.

11. The PCIe device of claim 8, wherein:
the at least one processor is further configured to:
receive a plurality of messages addressed to the remote device, wherein at least one of the messages of the plurality of messages includes a requested data value;
arbitrate the plurality of messages and the request for data message based on whether they include a requested data value;
select the request for data message based on the arbitrating.

12. The PCIe device of claim 8, wherein:
the at least one processor is further configured to:
receive a plurality of messages addressed to the remote device, wherein at least one of the messages of the plurality of messages includes a requested data value;
arbitrate the plurality of messages and the request for data message based on whether they include a requested data value and on a predetermined priority; and
select the request for data message based on the arbitrating.

13. The PCIe device of claim 8, further comprising:
a plurality of direct memory access (DMA) engines, wherein the request for data message is received from a DMA engine of the plurality of DMA engines, and
the at least one processor is further configured to:
receive, from the plurality of DMA engines, a plurality of messages addressed to the remote device, wherein at least one of the messages of the plurality of messages includes a requested data value;
arbitrate the plurality of messages and the request for data message based on whether they include a requested data value, on a DMA engine round robin methodology, and on a DMA engine priority methodology; and
select the request for data message based on the arbitrating.

14. A PCIe device arbiter comprising:
a memory buffer for storing data received from a Central Processing Unit (CPU) memory subsystem;
a first scheduler configured to schedule a plurality of messages requesting data from the CPU memory subsystem, the plurality of messages including a requested data value;
a second scheduler configured to schedule a plurality of messages that do not request data from the CPU memory subsystem;
at least one processor coupled to the memory buffer and the first scheduler configured to:
receive from the first scheduler a message requesting data from the CPU memory subsystem;
queue the received message when storage space available in the memory buffer is less than the requested data value; and
send the received message to the CPU memory subsystem when the storage space available in the memory buffer is at least the requested data value.

15. The PCIe device arbiter of claim 14, wherein:
the at least one processor is further configured to:
parse the received message to retrieve the requested data value.

16. The PCIe device arbiter of claim 14, wherein:
the at least one processor is further configured to:
monitor the storage space available in the memory buffer when the received message is queued.

17. The PCIe device arbiter of claim 14, wherein:
the first scheduler is further configured to schedule the plurality of messages requesting data in a round-robin format; and
the second scheduler is further configured to schedule the plurality of messages that do not request data in a round-robin format.

18. The PCIe device arbiter of claim 17, further comprising:
a priority scheduler coupled to the at least one processor and the second scheduler, configured to schedule sending of a message by the at least one processor and the second scheduler based on a predetermined priority.
